(19) United States
(12) Patent Application Publication
(10) Pub. No.: US 2014/0003696 A1
(43) Pub. Date: Jan. 2, 2014

(54) AUTOMATED TRAJECTORY PLANNING FOR STEREOTACTIC PROCEDURES

(71) Applicant: Alexander Taghva, Columbus, OH (US)

(72) Inventor: Alexander Taghva, Columbus, OH (US)

(73) Assignee: THE OHIO STATE UNIVERSITY, Columbus, OH (US)

(21) Appl. No.: 13/977,845

(22) PCT Filed: Dec. 29, 2011
(86) PCT No.: PCT/US2011/067947

§ 371 Date: Sep. 23, 2013

Related U.S. Application Data
(60) Provisional application No. 61/427,881, filed on Dec. 29, 2010.

(51) Int. Cl. G06T 7/00

(52) U.S. Cl. CPC G06T 7/0012
USPC 382/131

(57) ABSTRACT

Methods and apparatus for identifying and evaluating surgical stereotactic trajectories to a target area are disclosed. Entry points and trajectories are evaluated based on segmented images. The segmentation process may involve segmenting the anatomical region into discrete regions. Candidate entry points are evaluated according to image intensity following segmentation of the anatomical region. Candidate entry points may be refined according to various angle corridors. Following identification of a target area, for each candidate entry point, the proposed trajectory is evaluated using segmented image data (e.g., identifying tissue types) and image intensity. The final proposed trajectory is based on derivation of a statistic for each trajectory indicating the deviation at each point from the mean region of interest image intensity and selection of trajectory with the lowest statistic value. The proposed trajectory is then presented to a computer user.

### CROSS REFERENCES TO RELATED APPLICATIONS

This application claims priority to U.S. Provisional Application Ser. No. 61/427,881, filed on Dec. 29, 2010, the content of which is incorporated by reference as if fully recited herein.

### FIELD OF THE INVENTION

The invention relates generally to medical imaging technology and, in particular, to computerized medical imaging systems, apparatuses, and methods for stereotactic procedures such as deep brain stimulator placement.

### BACKGROUND OF THE INVENTION

Preoperative trajectory planning for stereotactic procedures such as stereotactic brain procedures is a time-consuming, and often suboptimal, manual process during which surgeons determine an ideal entry point and trajectory to reach a target. Manual planning is suboptimal because, while strong guidelines exist for good trajectories into the brain (e.g., avoid blood vessels and ventricles, enter on gyrus and not in sulcus, etc.), it is infeasible for surgeons to evaluate each possible trajectory. Furthermore, for procedures such as deep brain stimulation (DBS) where multiple passes are performed simultaneously (i.e., using a ben-gun during DBS), it is difficult to visually evaluate each trajectory simultaneously. In addition, given the wealth of structural (e.g., diffusion tensor imaging) and functional (e.g., fMRI) data available in the brain, it is infeasible for a surgeon to consider all possible trajectory angles and the implication for how the neuromodulation is affected. For these reasons, automated methods for trajectory planning are needed.

### SUMMARY OF THE INVENTION

The present disclosure describes methods for evaluating and selecting surgical stereotactic trajectories to a target area. The methods may be implemented in a computer comprising a memory for storing and manipulating image data and a display to support user interactions and presentation of image and trajectory data. In an example embodiment, the methods are based on brain imaging studies such as contrast-enhanced T1 thin-cut MRI, which is most commonly used for planning. Other sequences may be used. In addition, methods for evaluating and selecting targets using structural and functional imaging as well as device geometry are disclosed. Methods of refinement of the fit of the calculated trajectories to patient's actual anatomy are also disclosed. These include a method to co-register physiological data to image data and a method to co-register intra-operative imaging of an organ surface to the medical image to define the appropriate entry point.

Entry points and trajectories are evaluated based on segmented images. The segmentation process may involve segmenting the anatomical region into discrete regions. Candidate entry points are evaluated according to image intensity following segmentation of the anatomical region. Candidate entry points may be refined according to various angle corridors. Following identification of a target area, for each candidate entry point, the proposed trajectory is evaluated using segmented image data (e.g., identifying tissue types) and image intensity. A desired level of precision may be specified. Various techniques may be used to eliminate inappropriate trajectories. For example, in a stereotactic procedure involving the brain, trajectories that cross vessels, enter CSF spaces, or violate pial surfaces may be eliminated. The final proposed trajectory is based on derivation of a statistic for each trajectory indicating the deviation at each point from the mean region of interest image intensity and selection of a trajectory with the lowest statistic value. The proposed trajectory is then presented to a computer user.

### BRIEF DESCRIPTION OF THE DRAWINGS

FIG. 1 is an image for initiating trajectory planning according to an example embodiment;

FIG. 2 is a deformable model fitting for brain extraction according to an example embodiment;

FIG. 3 is a brain extract image according to an example embodiment;

FIG. 4 is a segmented image according to an example embodiment;

FIGS. 5 and 6 are sample trajectory viewer images according to an example embodiment;

FIG. 7 is planning station according to an example embodiment; and

FIG. 8 is a flow diagram of a trajectory planning technique according to an example embodiment.

### DETAILED DESCRIPTION

The system, apparatus, and methods of the invention facilitate selection of safe trajectories and entry points to a defined target area in an anatomical region such as the brain based on preoperative imaging studies, including MRI and CT. A target area is defined as the point or general region in the anatomical region (e.g., brain) to be reached by stereotactic procedure. An entry point is the point at which the anatomical region is entered from the outside. The trajectory is defined as the path (e.g., linear, non-linear continuous, non-continuous, or otherwise defined) from the entry point to the target area. The target area may be predefined or selected by the user with or without automated registration to a standardized anatomy atlas. Alternatively, the target area may be defined relative to anatomical landmarks. For example, in the brain the landmarks may include the anterior commissure (AC) and posterior commissure (PC), which may be identified interactively by the user or automatically identified.

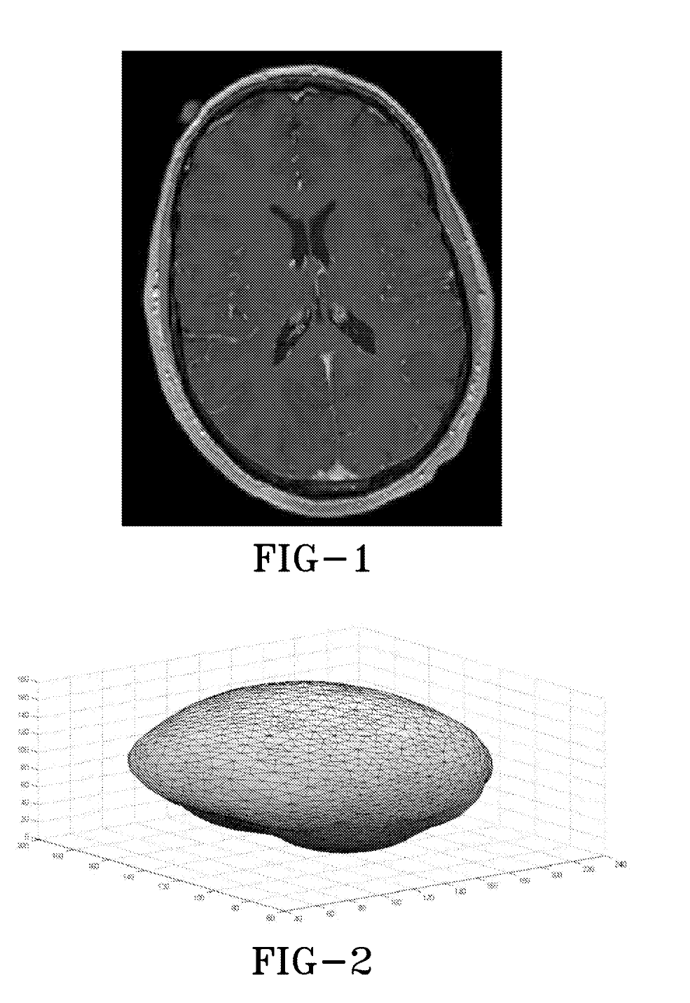

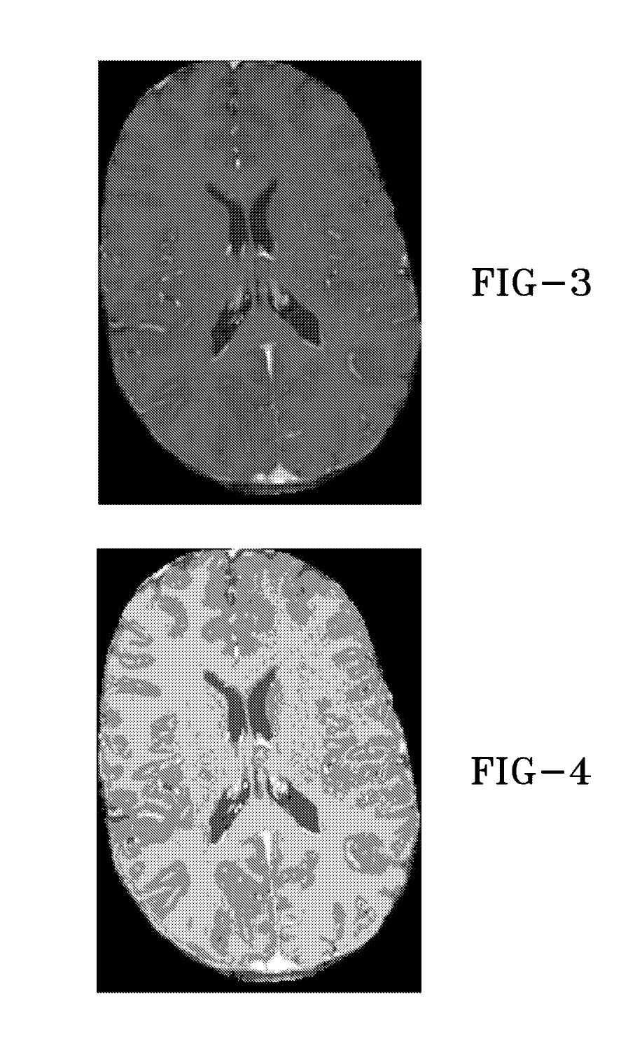

Referring to FIG. 1, an image for initiating trajectory planning according to an example embodiment is shown. An image (e.g., an MRI or CT scan) is obtained of the anatomical region of interest, such as the brain, to be reached by a stereotactic procedure. Referring to FIG. 2, a deformable model fitting for brain extraction according to an example embodiment is shown. The image data is uploaded into a software system where the image is automatically segmented into various tissue types. In the brain, a first algorithm extracts brain from non-brain background (including scalp, skull, etc.) using available techniques including a deformable model algorithm or other brain extraction algorithm. Referring to FIG. 3, a brain extract image according to an example embodiment is shown.

Once brain versus non-brain matter has been identified, the components of the image that comprise the brain are further subdivided into discrete regions which include, but are not limited to, cerebrospinal fluid (CSF), surface (pial) gray matter, subcortical gray matter, white matter, and blood vessels. Initial segmentation can be performed using many available methods including but not limited to k-means clustering, finite mixture modeling, or thresholding techniques followed by Markov Random Field (MRF) modeling with analysis by iterated conditional modes (ICM) algorithm^{2,3}. In addition, the MRI bias field may be calculated and accounted for prior to segmentation by use of available bias reduction techniques. Referring to FIG. 4, a segmented image according to an example embodiment is shown.

At this point, the user may define the target area in the brain to be reached by stereotactic procedure. Alternatively, in the case of a neuro-modulation procedure including deep brain stimulation, the user may select the brain regions to be modulated, either by manual selection of brain regions of interest (ROIs) or by incorporation of a functional brain imaging scan, such as functional MRI (fMRI), positron emission tomography (PET), or single-photon emission computed tomography (SPECT), where abnormal or highlighted regions in the studies are used as the ROI. Once the ROIs are selected for modulation, selection of the target area is performed by incorporation of a connectivity imaging study such as diffusion tensor imaging (DTI). The proposed target area is selected by finding the area with greatest white matter fiber projections heading to the ROIs. At least two separate methods or a combination of methods may be used to determine the target area with maximal projections to the ROIs to be modulated. First, the user may constrain the region where the target area may lie, and that region may be divided into a finite number of voxels that can be stepped through in turn. Each voxel is used as the “seed” for a tractographic analysis (e.g., deterministic tractography or probabilistic tractography). In an example embodiment, the voxel with maximal projections to the ROIs is selected as the best target area.

The second method that may be used is that each ROI is used as the “seed” for the tractographic analysis, and the region where there is maximal or most optimal overlap of white matter fibers from each ROI is determined to be the proposed ideal target area. In addition, templates of available neuromodulation devices (e.g., different deep brain stimulation electrode designs) may be used to define the geometry and spacing between seeds in this analysis. In this case, the user may either select the neuro-modulation device to be used from a preloaded set of templates or the user may provide a user-defined geometry. Alternatively, once the proposed target area is found, the software system may provide feedback as to the optimal geometry of neuro-modulation device to use, possibly from a set of preloaded templates.

Using the previously segmented medical image (e.g., from the brain), selection of potential entry points of the stereotactic probe into the brain or other organ is undertaken. In the case of the brain, candidate entry points are selected on the pial surface by identification of gray matter perimeter voxels using connected components and perimeter analysis to be no further than a set distance (e.g., 5 mm) from the brain surface. This approach prevents selection of entry points in a sulcus (rather than gyral peak) where blood vessels may be encountered and may endanger the patient. This selection alternatively may be implemented by selecting pial surface points where local curvature is positive as this represents a gyral peak.

Refinement of these candidate entry points based on appropriate sagittal, coronal, or other angle corridors following alignment of image (e.g., to AC-PC line using affine transformation or to a standardized brain atlas). Refinement of the corridor may also be performed by taking into account the geometry desired for placement of a device as determined during proposed target area selection.

For each trajectory from entry point to target area, the tissue types (from segmented image) as well as the image intensity is determined at each point along the trajectory at a desired level of precision. Following determination of the image intensity at each point along each trajectory from surface to target area, determination of the tissue class encountered by the stereotactic probe is also performed. From these data, both rule-based and statistical criteria may be applied to determine the best and safest trajectories. Typical rule-based criteria for brain procedures include but are not limited to eliminating trajectories that cross vessels, enter CSF spaces, or violate pial surfaces after initial entry. This filtering can be implemented using regular expressions or other pattern matching or equivalent techniques.

Final selection of the trajectory is based on derivation of a statistic for each trajectory indicating the deviation at each point from the mean white matter intensity and selection of trajectory with the lowest statistic value. Other definitions for defining “safe” image intensities may be used as well as other suitable statistics including root-mean squared deviation, standard deviation, and others. In this method, regional characteristics including median intensity, variance, and others may be used to refine the statistic. This technique serves to refine rule selection by selecting trajectories that have the smallest deviations from “safe” white-matter based paths. If desired, “safe” tracks may be along gray matter or CSF pathways. The statistic works to refine the rule-based trajectory elimination. For example, a vessel that is misclassified as white matter has a higher intensity (and therefore deviation) than a typical white matter voxel.

A similar statistic for neighboring voxels or multiple trajectories separated by a computable geometric quantity may also be computed and evaluated and is added with or without weighting to the statistic value for the main trajectory. One method of weighting the neighboring voxels is by the inverse of the distance from the center of the trajectory (i.e., closer neighboring voxels are weighed more). This technique increases the safety of passing through adjacent regions to account for errors with registration of images to patient anatomy and brain shift during surgery.

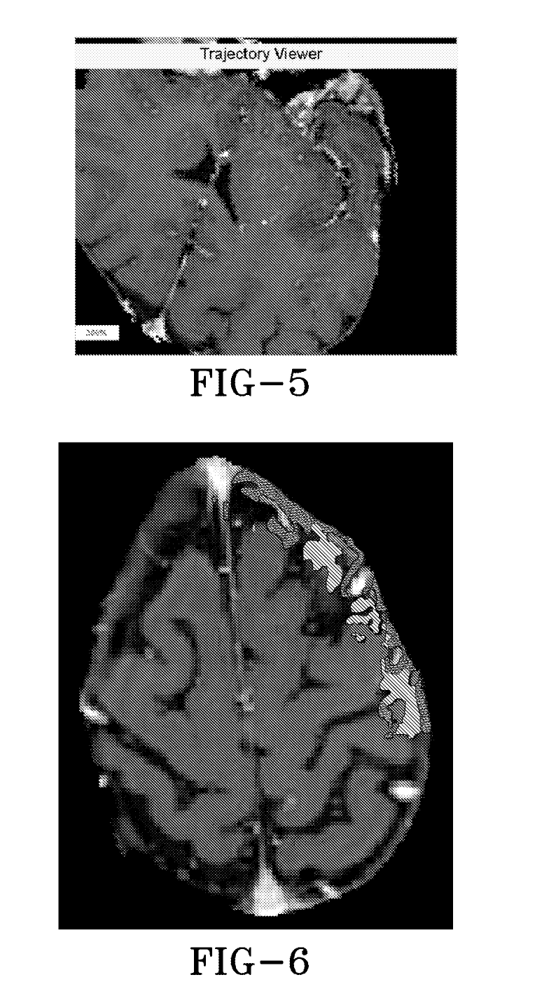

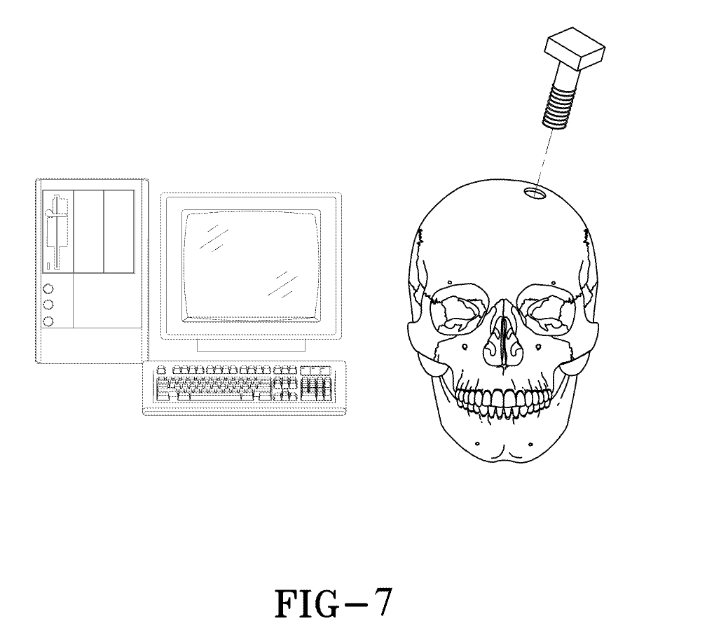

Referring to FIG. 5, a sample trajectory viewer image according to an example embodiment is shown. The user is presented with a trajectory view to manually review the selected trajectory as well as a highlighted brain surface map with entry points highlighted by their statistic penalty value if the surgeon chooses to select an alternate trajectory (as shown in FIG. 6).

Referring to FIG. 7, a planning station according to an example embodiment is show. The planning station comprises a computer screen for displaying trajectories and accepts image data and electrode recording data from a network or other media. A camera with a transmitter and screw threads or other mounting component is connected through a skull burr hole. The camera may be used to capture images and transmit them to the workstation so that the computer user can assess real-time brain shift.

The user may also be presented with a display for each trajectory showing the overlay of the stereotactic object to be inserted the brain or other organ. For example, a template of the model of a DBS electrode may be shown on a 3D model of the brain along the selected trajectory. In the case of a neuromodulation device such as a DBS electrode, the user can view the white matter tracts that may be modulated by the device using tractographic analysis as described above and using the modulatory portions of the device as the “seeds” for tractography. In this way, the user can select the trajectory that allows him to modulate the regions of the brain desired. For instance, in the case of a quadripolar DBS electrode, a template of such an electrode with accurate spacing and size of electrode leads may be overlaid on the trajectory, each electrode lead on the DBS electrode may be used for tractographic analysis, and the user may see which parts of the brain are modulated with each trajectory.

Following selection of the proposed trajectory, the entry point and target area may be used in any available stereotactic co-registration system (frame-based or frameless stereotaxy) to then guide the surgeon to the appropriate entry point on the patient's brain or other organ. During surgery, classification of microelectrode recording signals may be used to provide feedback to the user regarding how closely the planned trajectory matches the actual trajectory by classification of the electrophysiological signals using established methods (e.g., Hidden Markov Models, clustering). One particular technique for matching signal classifications to the medical image involves transforming the class assigned to the signal at a given location to an image intensity value. The signal is then registered to the image using a mutual information maximization algorithm, with the signal class maximized against image intensity values. This technique may also be applied to registration of a standard brain atlas to the patient's brain and maximization of the mutual information between the intra-operative signal classification and anatomical region as delineated by the atlas. The signal is then registered to the brain by composition of the registration of the signal to the atlas and the atlas to the brain.

In addition, the fit of the acquired medical image to the actual patient anatomy accounting for brain or other organ shift during surgery may be refined by taking an intraoperative digital photograph of the visualized region during surgery, for example, a digital photograph of the brain surface through the bur hole made during DBS surgery. This digital photograph is co-registered to the medical image using known methods, including possibly mutual information maximization, to the surface of the brain as already segmented by the invention. In this way, the exact location of the entry point calculated on the surface of the brain relative to the medical image can be calculated, even accounting for brain shift during surgery. The correct location of the electrode entry point can then be indicated to the surgeon on the screen by displaying the intra-operative photograph and overlaying the correct location of the entry point.

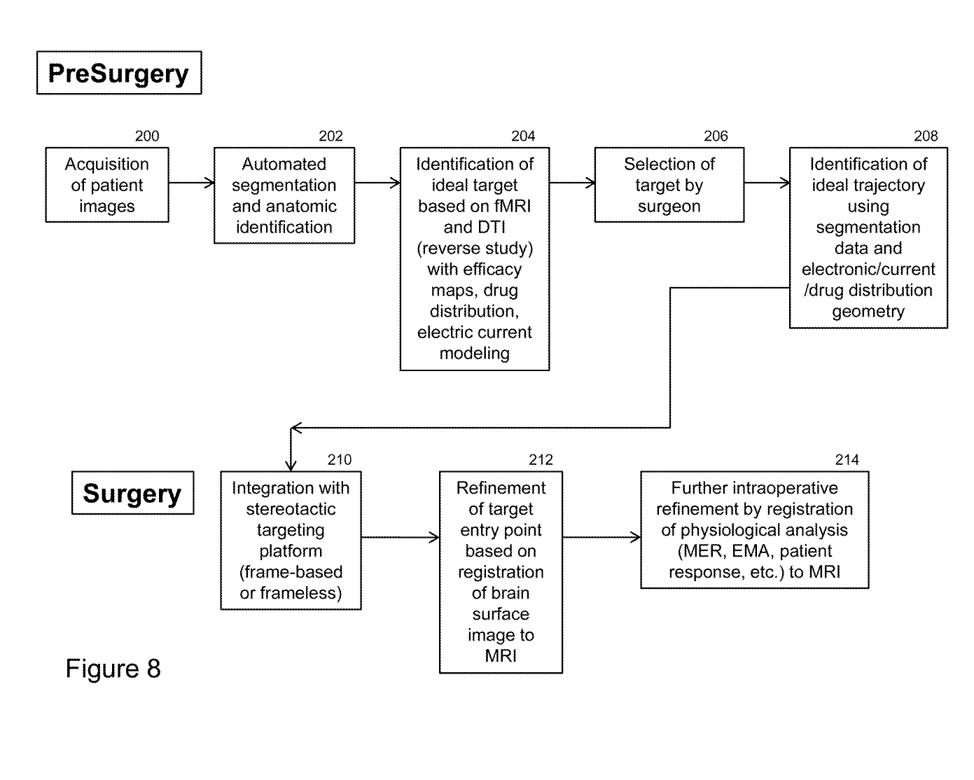

Referring to FIG. 8, a flow diagram of a trajectory planning technique according to an example embodiment is shown. In an example embodiment, the technique involves a pre-surgery, planning phase 200, 202, 204, 206, 208 and a surgery phase 210, 212, 214 during which the target entry points may be refined. In step 204, target selection may be refined based on volume of distribution of a drug or other therapeutic agent, known stimulation efficacy maps (e.g. anatomical atlases indicating therapeutic locations for electrode placement), or electrical current modeling.

In step 208, targets and trajectories may be further refined by a template matching algorithm showing the lead locations with various deep brain stimulator or epilepsy depth monitoring electrodes. The user may then identify the brain areas modulated on the specified trajectory by integration of the trajectory with DTI, using the electrode locations as the seeds for the diffusion tensor computation. Conversely, the user may specify, either by manual selection of an ROI or by incorporation of a functional image, the areas to be modulated by stimulation, and suitable trajectories may be ranked by the fibers (as calculated by DTI) sent to the specific regions. in addition, nonlinear paths may be computed. Furthermore, the proposed location and target for a given procedure may be suggested to the user by receiving user selection of the ROIs (as noted above) to be modulated, then using those ROIs as seeds for the DTI and showing the areas of overlap of fibers from each ROI and area of maximal overlap or intersection using standard or probabilistic diffusion tensor imaging.

In step 212, brain shift and ensuring that the appropriate entry point is taken may be calculated by intraoperative digital photograph of the brain surface through the bur hole. This digital photograph may be registered using standard methods, including possibly mutual information maximization, to the surface of the brain as already segmented. In this way, the exact location of the entry point on the surface of the brain relative to the medical image can be calculated, even accounting for brain shift during surgery. The correct location of the electrode entry point can then be indicated to the surgeon on the screen by displaying the intraoperative photograph and overlaying the correct location of the entry point.

In step 214, during surgery, classification of microelectrode recording signals may be used to provide feedback to the user regarding how closely the planned trajectory matches the actual trajectory by classification of the electrophysiological signals using established methods (HMM, clustering). Matching of the signal classification to the medical image may be accomplished by transforming the class assigned to the signal at a given location to an image intensity value, then registering the signal to the image using a mutual information maximization algorithm, with the signal class maximized against image intensity values. This may also be done in conjunction with registration of a standard brain atlas to the patient's brain and maximization of the mutual information between the intraoperative signal classification and anatomical region as delineated by the atlas. The signal is then registered to the brain by composition of the registration of the signal to the atlas and the atlas to the brain.

The present invention facilitates the identification and evaluation of surgical stereotactic trajectories to a target area. Various methods may be used for stereotactic procedures involving various anatomical regions. While certain embodiments of the present invention are described in detail above, the scope of the invention is not to be considered limited by such disclosure, and modifications are possible without departing from the spirit of the invention as evidenced by the claims. Although an example embodiment for a brain stereotactic procedure is described, the disclosed method may be used in procedures involving other anatomical regions. Various techniques for performing certain steps may be used and fall within the scope of the claimed invention. For example, various techniques for defining segments may be used and fall within the scope of the claimed invention. Various software features and functionality may be varied and fall within the scope of the claimed invention. One skilled in the art would recognize that such modifications are possible without departing from the scope of the claimed invention.

### REFERENCES

1. Smith S M. Fast robust automated brain extraction. Hum Brain Mapp. November 2002; 17(3):143-155.
2. Besag J. On the statistical analysis of dirty images. J R Stat Soc B. 1986;48:259-302.
3. Zhang Y, Brady M, Smith S. Segmentation of brain MR images through a hidden Markov random field model and the expectation-maximization algorithm. IEEE Trans Med Imaging. January 2001; 20(1):45-57.

What is claimed is:

1. A computerized method for identifying a trajectory to a target area for a stereotactic procedure based on imaging data comprising:
(a) receiving at a computer patient image data for an anatomical region to be reached by a stereotactic procedure;
(b) generating at said computer using said image data a segmented image comprising a plurality of discrete regions for said anatomical region;
(c) identifying at said computer in said segmented image a proposed target area;
(d) identifying at said computer a plurality of proposed entry points for reaching said target area;
(e) for each proposed entry point, calculating at said computer a proposed trajectory to said target area using said segmented image and geometry data; and
(f) generating for display at said computer on said segmented image at least one proposed trajectory.

2. The method of claim 1 further comprising
(g) transmitting from said computer to a stereotactic targeting platform data for said proposed trajectory.

3. The method of claim 2 further comprising:
(h) receiving at said computer from said stereotactic targeting platform actual entry point data; and
(i) refining at said computer said proposed entry point based on said actual entry point data.

4. The method of claim 2 further comprising:
(h) receiving at said computer from said stereotactic targeting platform actual trajectory data;
(i) comparing at said computer said proposed trajectory data said actual trajectory data; and
(j) generating at said computer a display illustrating a match between said proposed trajectory and said actual trajectory.

5. The method of claim 1 wherein calculating at said computer a proposed trajectory to said target area using said segmented image comprises analyzing image intensity at a plurality of points along said proposed trajectory.

6. The method of claim 5 further comprising determining at said computer a tissue type at a plurality of points along said proposed trajectory.

7. The method of claim 1 wherein receiving at a computer patient image data for an anatomical region to be reached by a stereotactic procedure comprises receiving patient image data for a brain.

8. An apparatus for identifying a trajectory to a target area for a stereotactic procedure based on imaging data comprising:
(a) a memory store for storing patient image data for an anatomical region to be reached by a stereotactic procedure; and
(b) a processor executing programming instructions to:
(1) generate using said image data a segmented image comprising a plurality of discrete regions for said anatomical region;
(2) identify in said segmented image a proposed target area;
(3) identify a plurality of proposed entry points for reaching said target area;
(4) for each proposed entry point, calculating a proposed trajectory to said target area using said segmented image and geometry data; and
(c) a display for displaying to a computer user on said segmented image at least one proposed trajectory.

9. The apparatus of claim 8 wherein said processor further executes a program instruction to (5) transmit from said computer to a stereotactic targeting platform data for said proposed trajectory.

10. The apparatus of claim 9 wherein said processor further executes programming instructions to:
(6) receive from said stereotactic targeting platform actual entry point data; and
(7) refine said proposed entry point based on said actual entry point data.

11. The apparatus of claim 9 wherein said processor further executes programming instructions to:
(6) receive from said stereotactic targeting platform actual trajectory data;
(7) compare said proposed trajectory data said actual entry point data; and
(8) generate a display for said computer user illustrating a match between said proposed trajectory and said actual trajectory.

12. The apparatus of claim 8 wherein said programming instruction to calculate a proposed trajectory to said target area using said segmented image comprises analyzing image intensity at a plurality of points along said proposed trajectory.

13. The apparatus of claim 8 wherein said processor further comprises programming instructions to determine a tissue type at a plurality of points along said proposed trajectory.

14. The apparatus of claim 8 wherein said patient image data for an anatomical region to be reached by a stereotactic procedure comprises patient image data for a brain.

15. A computerized method for selecting entry points and trajectories to a target area for a stereotactic brain procedure based on an imaging study comprising:
(a) identifying a plurality of candidate entry points using a segmented image;
(d) refining said candidate entry points according to a selected corridor;
(e) for each proposed entry point, calculating at said computer a proposed trajectory to said target area by determining at a plurality of points along said trajectory an image intensity and tissue class;
(f) applying a filtering procedure to said proposed trajectories to eliminate trajectories according to established criteria for brain procedures; and
(g) identifying a final trajectory by deriving a statistic for each trajectory indicating a deviation at each point from mean white matter intensity and selecting a trajectory with a lowest statistic value.

16. The computerized method of claim 15 wherein said selected corridors are selected from the group consisting of saggital or coronal corridors.

17. The computerized method of claim 15 wherein applying a filtering procedure to said proposed trajectories to eliminate trajectories comprises eliminating trajectories that cross vessels, enter CSF spaces, or violate pial surfaces after initial entry.

18. A computerized method for identifying candidate entry points into a brain based on tissue type, local surface curvature, angular corridor relative to a target area, comprising:
(a) segmenting a medical image of a brain into a plurality of discrete regions;
(b) specifying a surface distance from said brain; and
(c) identifying a plurality of candidate entry points on a pial surface of said brain by identifying gray matter perimeter voxels using connected components and perimeter analysis according to said surface distance.

19. A computerized method for eliminating unsafe trajectories in a stereotactic brain procedure comprising:
(a) identifying at a computer a plurality of candidate entry points using imaging data;
(b) calculating at said computer a plurality of trajectories from each of said candidate entry points to a target area;
(c) applying at said computer to each trajectory a pattern-matching technique wherein said technique evaluates:
(1) tissue types identified in said imaging data for said trajectory;
(2) image intensities traversed along said trajectory;
(d) presenting at said computer data to facilitate eliminating trajectories that violate criteria for brain procedures.

20. A computerized method for evaluating the safety of a trajectory comprising:
(a) identifying at a computer a plurality of candidate trajectories using imaging data by determining at a plurality of points along each candidate trajectory an image intensity and tissue class; and
(b) calculating at said computer for each candidate trajectory a statistic indicating a deviation at each point from a mean white matter intensity; and
(c) presenting said computer said statistical data for each trajectory.

21. The computerized method of claim 20 further comprising identifying at said computer a trajectory with a lowest statistic value.

22. The computerized method of claim 20 wherein said statistic is selected from the group consisting of root-mean squared deviation and standard deviation.

23. The computerized method of claim 20 further comprising refining said statistic using regional characteristics in said imaging data.

24. The computerized method of claim 23 wherein said regional characteristic is selected from the group consisting of median intensity and median variance.

25. The computerized method of claim 20 wherein said statistic is refined by calculating and applying a statistic to neighboring voxels.

26. The computerized method of claim 20 wherein said statistic is refined by calculating and applying a statistic for multiple trajectories separated by a computable geometric quantity.

27. A computerized method for displaying a trajectory on an image of a brain modulated by an electrode implantation comprising:
(a) receiving at a computer a location of leads on said trajectory;
(b) integrating on a display of said image said trajectory with structural connectivity data from said brain image; and
(c) displaying statistical values associated with alternatives to said trajectory.

28. A computerized method for selecting a target for a given procedure by calculation of maximal overlap of connecting fibers from regions to be modulated comprising:
(a) selecting at a computer from an image a plurality of regions of interest;
(b) determining at said computer a maximal overlap of white matter fibers from each region of interest; and
(c) identifying said maximal overlap as a target.

29. The computerized method of claim 28 further comprising applying a template of a neuromodulation device to define a geometry and spacing between points for said target.

30. A computerized method for registration of electrophysiologic data to image data comprising:
(a) receiving at a computer a plurality of microelectrode signals for a trajectory;
(b) comparing at said computer said microelectrode signals for said trajectory to image intensity values for a proposed trajectory by:
(1) transforming a class assigned to said signal at a given location to a signal image intensity value; and
(2) registering said signal image intensity value to said image intensity value.

31. The computerized method of claim 30 wherein said signal image intensity value is registered to said image intensity value using a mutual information maximization algorithm.

32. A computerized method for accounting for brain shift during surgery comprising:
(a) receiving at a computer an interoperative digital image of a brain surface; and
(b) registering said intraoperative digital image to a segmented, preoperative image.

33. The computerized method of claim 32 further comprising displaying said registered image and overlaying on said image an entry point.

34. The computerized method of claim 33 wherein a template matching algorithm is applied to show a lead location for said entry point.

35. The computerized method of claim 34 wherein said lead location is a seed for a diffusion tensor computation.

36. The computerized method of claim 32 further comprising:
(c) receiving at said computer a user selection of at least one area to be modulated; and
(d) identifying a plurality of trajectories for said area.

37. The computerized method of claim 36 wherein said plurality of trajectories are ranked by fibers using a diffusion tensor computation.
